(19) United States
(12) Patent Application Publication
(10) Pub. No.: US 2004/0184373 A1
(43) Pub. Date: Sep. 23, 2004

(54) Recording method, recording apparatus, optical recording medium and computer readable recording medium storing the recording method

(75) Inventors: Sung-hee Hwang, Seoul (KR); Jung-wan Ko, Gyeonggi-do (KR); Kyung-geun Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/800,871

(22) Filed: Mar. 16, 2004

(30) Foreign Application Priority Data
Mar. 17, 2003 (KR) 2003-16498
Mar. 22, 2003 (KR) 2003-18021
Jan. 3, 2004 (KR) 2004-179

(51) Int. Cl. G11B 7/00

(52) U.S. Cl. 369/47.14

(57) ABSTRACT

A recording method, a recording apparatus, an optical recording medium, and a computer readable recording medium storing a program for the recording method, wherein the method includes separately recording temporary defect information with a size equal to a multiple (N=0,1,2, . . . ) of a predetermined size (K) among entire temporary defect information, and remaining temporary defect information, excluding the temporary defect information with the size equal to K×N, among the entire temporary defect information to an optical recording medium.

### CROSS-REFERENCE TO RELATED APPLICATIONS

This application claims the priorities of Korean Patent Application No. 2003-16498, filed on Mar. 17, 2003, Korean Patent Application No. 2003-18021, filed on Mar. 22, 2003, and Korean Patent Application No. 2004-179, filed on Jan. 3, 2004 in the Korean Intellectual Property Office, the disclosures of which are incorporated herein in their entireties by reference.

### BACKGROUND OF THE INVENTION

1. Field of the Invention

The present invention relates to a method of recording defect management information, a recording apparatus, an optical recording medium, and a computer readable recording medium storing a program of the recording method.

2. Description of the Related Art

In defect management, user data is rewritten on a defective portion of a user data area to compensate for data loss due to the occurrence of defects. Defect management is classified into defect management methods using linear replacement and defect management methods using skipping replacement. In linear replacement, a defective portion is replaced by a non-defective portion of a spare area when a defect is generated in a user data area. In skipping replacement, a defective portion is “skipped” and only non-defective areas are used.

Both the linear replacement and skipping replacement methods are only applicable to a disk allowing repetitive recording and recording by a random access method, such as DVD-RAM/RW. In other words, applying the linear replacement method or the skipping replacement method to a write once disk, which can be written to once, is difficult. This is because, in the linear replacement and skipping replacement methods, whether a defect is generated is determined after data is recorded on a disk.

High-density write once disks with a recording capacity of dozens of GB following CD-R standards, DVD-R standards, etc. have been developed. Because a write once disk has a relatively low price, allows random access, and can be read at a relative high speed, the write once disk can be used for data backup. However, because defect management for such a write once disk is not performed, data backup can be interrupted if a defective portion is generated during data backup. Furthermore, because data backup is performed during periods of relatively low system use, for example, during the night when a system manager is absent, if a defective portion is generated during data backup and data backup is interrupted, the interrupted status may be unresolved.

A write once medium on which defect management can be performed by a drive includes areas storing information managing defects generated while the disk is being used and information indicating a recorded status of the disk. Because a rewrite operation can be performed on the write once medium as in a rewritable device when an information update is required, the write once medium requires a large storage capacity in order to ensure a desired level of update.

Meanwhile, during the defect management performed by the drive, defect information, obtained by error checking after writing data, is temporarily stored as temporary defect information. If data recording on the disk is complete, that is, if there is no more data to be recorded on the disk (that is, when data is finalized), the temporary defect information recorded on the disk and temporary defect management information regarding locations of the temporary defect information are recorded on a defect management area of the disk.

FIG. 1A is a view explaining a conventional method of recording temporary defect information. The method illustrated by FIG. 1A is a general method in which temporary defect information is accumulated and stored.

The temporary defect information is updated during each recording operation, wherein the operation may be a verify-after-write operation (or a plurality of verify-after-write operations) in which a predetermined sector or cluster is written and verified, or may be an eject operation in which a disk is inserted into a drive, data is recorded on the disk or recorded data is reproduced on the disk, and the disk is ejected.

Referring to FIG. 1A, in a recording operation #1, information regarding a defect #0 is recorded, in a recording operation #2, information regarding a defect #1 and the information regarding the defect #0 are accumulated and recorded, in a recording operation #3, information regarding a defect #2, the information regarding the defect #1 and the information regarding the defect #0 are accumulated and recorded, in a recording operation #4, information regarding a defect #3, the information regarding the defect #2, the information regarding the defect #1, and the information regarding the defect #0 are accumulated and recorded. The recording operations #5 and #6 operate in a similar manner.

In this temporary defect information recording method, as an update count increases, the amount of temporary defect information increases. Accordingly, the number of clusters required for data recording increases and a larger temporary defect information area storing temporary defect information is required.

To solve such a problem, a method in which only defect information generated in a corresponding recording operation is recorded rather than accumulating and storing temporary defect information, has been developed.

FIG. 1B is a view explaining a conventional method of recording temporary defect information. In the method illustrated by FIG. 1B only temporary defect information generated in a corresponding recording operation is recorded.

Referring to FIG. 1B, in a recording operation #1, information regarding a defect #0 generated in the corresponding recording operation #1 is recorded, in a recording operation #2, information regarding a defect #1 generated in the recording operation #2 is recorded, and in a recording operation #3, information regarding a defect #2 generated in the recording operation #3 is recorded. As such, each operation records only defect information generated in the corresponding operation.

According to this conventional method, recording an equivalent amount of temporary defect information in a smaller area than used by the method shown in FIG. 1A, is possible. However, because the conventional method requires a process in which all data from a portion where the information regarding the defect #0 is recorded to a portion where the information regarding a last defect is recorded is read and arranged in order to obtain final temporary defect information, data reproduction is time-consuming and complicated.

### SUMMARY OF THE INVENTION

The present invention provides a recording method, a recording apparatus, and an optical recording medium, for efficiently reading temporary defect information while reducing a capacity required for the temporary defect information.

According to an aspect of the present invention, there is provided a recording method including separately recording temporary defect information with a size equal to a multiple (N=0,1,2, . . . ) of a predetermined size (K) among the entire temporary defect information, and recording the remaining temporary defect information, excluding the temporary defect information with the size equal to K×N among the entire temporary defect information to an optical recording medium.

According to an aspect of the present invention, the method includes recording size information of the temporary defect information with the size equal to K×N, information indicating a location of the temporary defect information with the size equal to K×N, and information indicating a location of the remaining temporary defect information excluding the temporary defect information with the size equal to K×N to the optical recording medium.

According to an aspect of the present invention, the optical recording medium is a write once medium.

According to another aspect of the present invention, there is provided a recording method including continuously recording temporary defect information with a size equal to a multiple (N=0, 1, 2, . . . ) of a predetermined size (K) among the entire temporary defect information to at least one portion of an optical recording medium; and accumulating and recording the remaining temporary defect information excluding the temporary defect information with the size equal to K×N among entire temporary defect information, to the optical recording medium during each operation, until a size of the accumulated temporary defect information reaches K.

According to an aspect of the present invention, the recording method further includes recording size information of temporary defect information with a size (K×N) equal to a multiple (N=0, 1, 2, . . . ) of a predetermined size (K), information indicating a location of the temporary defect information with the size equal to the multiple of the predetermined size, and information indicating a location of the accumulated temporary defect information, to the optical recording medium.

According to an aspect of the present invention, the recording method further comprises: if a size of the remaining temporary defect information reaches the predetermined size K during one of the operations, continuously recording the temporary defect information with the size equal to K×N and the remaining temporary defect information excluding the temporary defect information with the size equal to K to at least one portion of the optical recording medium.

According to an aspect of the present invention, the recording method further includes recording size information (K×N+K) of the continuously recorded temporary defect information and information indicating a location of the continuously recorded temporary defect information to the optical recording medium.

According to still another aspect of the present invention, there is provided a computer-readable medium having embodied thereon a computer program executing a recording method including separately storing temporary defect information with a size equal to a multiple (N=0, 1, 2, . . . ) of a predetermined size (K) among the entire temporary defect information, and accumulated temporary defect information excluding the temporary defect information with the size equal to K×N among the entire temporary defect information; and storing size information for the temporary defect information with the size equal to K×N, information indicating a location of the temporary defect information with the size equal to K×N, and information indicating a location of the remaining temporary defect information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a view explaining a conventional method of recording temporary defect information;

FIG. 1B is a view explaining a conventional method of recording temporary defect information;

FIG. 2 is a schematic block diagram of a recording apparatus according to an embodiment of the present invention;

FIG. 3 is a detailed block diagram of the recording apparatus of FIG. 2;

FIG. 4 is a flowchart illustrating a recording method according to an embodiment of the present invention;

FIG. 5 illustrates a structure of a temporary defect information area in which temporary defect information is stored and a temporary defect management area in which temporary defect management information is stored, according to an embodiment of the present invention;

FIG. 6 illustrates a structure of information to be recorded to the temporary defect information area and the temporary defect management area, according to an embodiment of the present invention;

FIGS. 7A-7C illustrate data structures of temporary defect management information, according to an embodiment of the present invention;

FIG. 8 is a flowchart illustrating a recording method according to an embodiment of the present invention;

FIG. 9 is a view explaining temporary defect information that is recorded in the recording method of FIG. 8;

FIG. 10 is a view explaining temporary defect information that is recorded in the recording method of FIG. 8; and

FIG. 11 is a view explaining temporary defect information that is recorded in the recording method of FIG. 8.

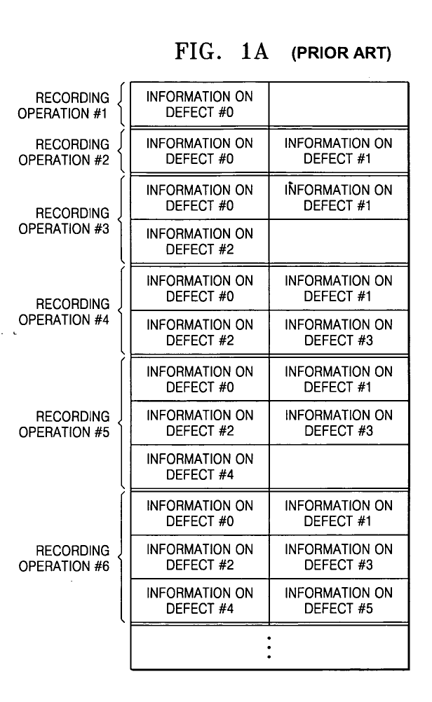

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

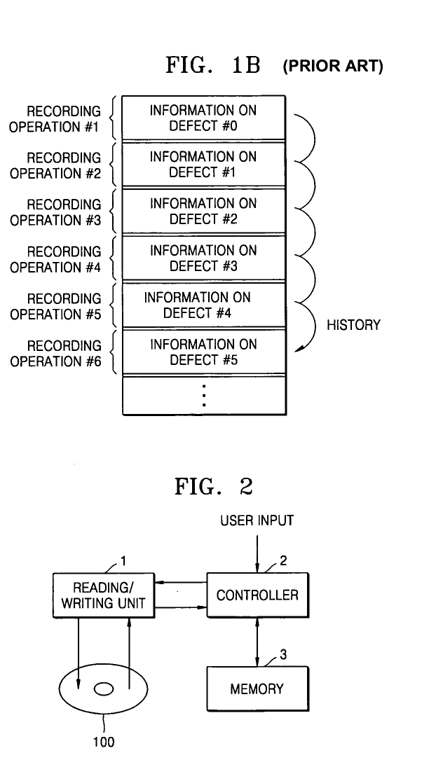

FIG. 2 is a schematic block diagram of a recording apparatus according to an exemplary embodiment of the present invention. Referring to FIG. 2, the recording apparatus includes a reading/writing unit 1, a controller 2, and a memory 3. The reading/writing unit 1 records data to a disk 100, which is a recording medium according to an exemplary embodiment of the present invention, and reads the recorded data to verify the data. The controller 2 performs defect management according to an exemplary embodiment of the present invention. The controller 2 performs defect management according to a “verify after write” method that detects a defective portion by writing data to each predetermined unit and verifying the written data. The controller 2 writes and verifies user data during each recording operation, thereby detecting where the defective portion is located. The controller 2 creates defect information indicating a location of the defective portion according to the detected result, stores the defect information in the memory 3, accumulates a predetermined amount of the defect information, and records the accumulated defect information as temporary defect information on the disk 100.

A “recording operation” is a task unit determined according to a user's request, a recording task to be performed, etc., which indicates a time required to load a disk 100 in a recording apparatus, recording predetermined data on the disk 100, and ejecting the disk 100 from the recording apparatus. The verify after write process is performed at least once, and generally, a plurality of times, during one recording operation. Defect information obtained by the verify after write process is temporarily stored as temporary defect information in the memory 3.

When a user presses an eject button (not shown) of the recording apparatus to eject the disk 100 after completing data recording, the controller determines that one recording operation is terminated. At this time, the controller 2 reads the temporary defect information stored in the memory 3, provides the temporary defect information to the reading/writing unit 1, and commands the reading/writing unit 1 to record the temporary defect information on the disk 100.

That is, if all data is recorded on the disk 100, in other words, if a user does not want to record additional data on the disk 100 (i.e., when data is finalized), the controller 2 records the temporary defect management information and temporary defect information recorded on the disk 100 on a defect management area provided on the disk 100.

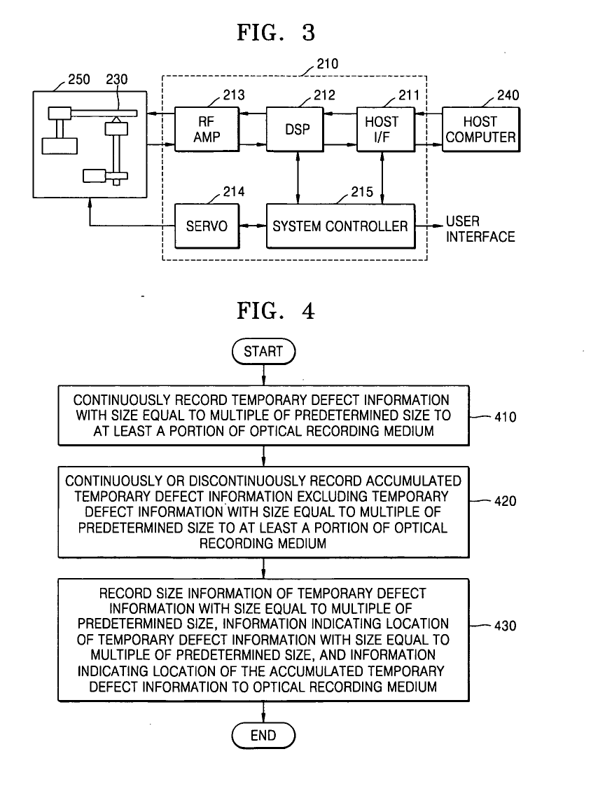

FIG. 3 is a detailed block diagram of the recording apparatus of FIG. 2. Referring to FIG. 3, the recording apparatus includes a pickup 250 as a reading/writing unit 220. A disk 230 is input to the pickup 250. The disk drive also includes a control unit 210 which includes a host I/F 211, a DSP 212, an RF amplifier 213, a servo 214, and a system controller 215.

When recording data, the host I/F 211 receives a predetermined recording command from a host computer and transmits the command to the system controller 215.

The temporary defect information with n size equal to a multiple (N=0, 1, 2, . . . ) of a predetermined unit size K among the entire temporary defect information is recorded separately from the remaining temporary defect information, excluding the temporary defect information with n size equal to the multiple of the predetermined unit size K, in response to the system controller 215. Size information of the temporary defect information with the size equal to K×N, information indicating the location of the temporary defect information with the size equal to K×N, and information indicating a location of the accumulated temporary defect information are also recorded in response to the system controller 215.

In other words, the system controller 215 controls accumulation of previous temporary defect information during each operation until the amount of the accumulated temporary defect information to be recorded reaches a predetermined size.

If the amount of the temporary defect information exceeds the predetermined size, the system controller 215 records only the accumulated temporary defect information without accumulating the temporary defect information with the predetermined size.

If the accumulated temporary defect information excluding the predetermined size reaches the predetermined size, the accumulated temporary defect information is added with the previous temporary defect information with the predetermined size and both the accumulated and predetermined size temporary defect information are continuously recorded. That is, the temporary defect information that is double the predetermined size is continuously recorded in response to the system controller 215.

The DSP 212 adds data (to be recorded) received from the host I/F 211 with additional data, such as parity information, for error correction, performs error correction code (ECC) encoding, creates an ECC block and then modulates the ECC block using a predetermined method. The RF amplifier 213 converts data output from the DSP 212 into an RF signal. The pickup 250 records the RF signal output from the RF amplifier 213 to the disk 230. The servo 214 receives commands required for servo control from the system controller 215 to servo-control the pickup 250.

When data is reproduced, the host I/F 211 receives a reproduction command from a host computer 240. The system controller 215 performs initialization for reproduction. Specifically, the system controller 215 controls reading of temporary defect management information from a predetermined area of the disk, detecting a recorded location of temporary defect information from the read temporary defect management information, and reading the temporary defect information.

The pickup 250 irradiates a laser beam on the disk 230, receives the laser beam after the beam is reflected by the disk 230, and outputs an optical signal obtained from the received laser beam. The RF amplifier 213 converts the optical signal output from the pickup 250 into an RF signal and provides modulated data obtained from the RF signal to the DSP 212. The DSP 212 demodulates the modulated data, performs ECC correction on the demodulated data, and outputs ECC-corrected data.

The servo 214 receives the servo signal from the RF amplifier 213 and receives the commands for servo-control from the system controller 215 to servo-control the pickup 250. The host I/F 211 sends data received from the DSP 212 to the host computer 240.

FIG. 4 is a flowchart illustrating a method of recording temporary defect information according to an embodiment of the present invention. Referring to FIG. 4, a multiple of a predetermined size of temporary defect information is recorded continuously on at least one section of an optical recording medium in operation 410.

For example, assuming that the predetermined size K is “4”, then, when the size of the entire temporary defect information exceeds “4”, temporary defect information with a size equal to “4” is recorded continuously. When the size of the entire temporary defect information exceeds “8”, temporary defect information with a size equal to “8” is recorded continuously.

Next, the remaining temporary defect information excluding a multiple of a predetermined size of temporary defect information among the entire temporary defect information is recorded continuously or discontinuously to the area where the temporary defect information with the size equal to the multiple of the predetermined size is recorded in at least a portion of the optical recording medium in operation 420.

For example, assuming that a predetermined size is “4”, then if the size of the accumulated temporary defect information is less than “4”, the accumulated temporary defect information is accumulated until the amount of the accumulated temporary defect information reaches “4”. If the size of the accumulated temporary defect information exceeds “4”, the temporary defect information (for example, information with a size of “1”) exceeding the predetermined size of “4” is recorded continuously or discontinuously on a following area of the area on which the temporary defect information with the size of “4” is recorded.

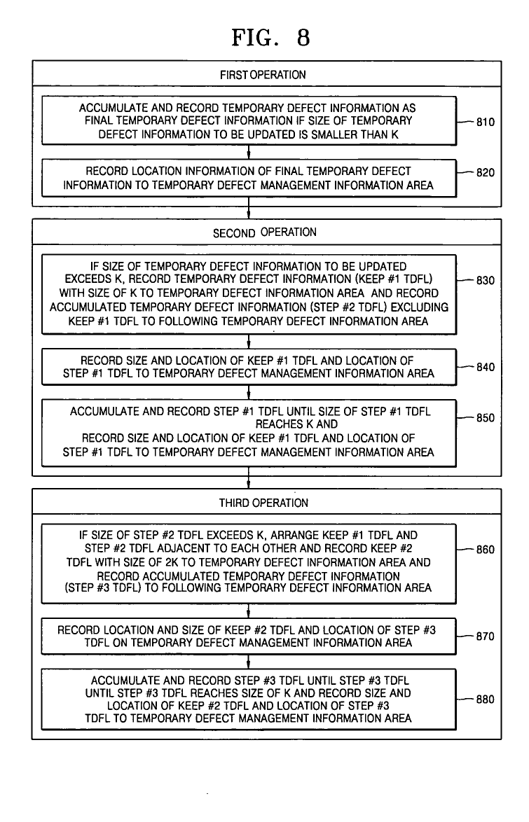

Then, size information of the temporary defect information with the size equal to the multiple of the predetermined size, information regarding a location of the temporary defect information with the size equal to the multiple of the predetermined size, and information regarding a location of the accumulated temporary defect information is recorded to the optical recording medium in operation 430. The recording method according to the present invention will be described in detail with reference to FIG. 8.

By individually recording the temporary defect information with the predetermined size and the accumulated temporary defect information, and recording the size and location information for the temporary defect information with the predetermined size and the location information of the accumulated temporary defect information, efficiently detecting temporary defect information using the location and size information and reducing the space required for storing the temporary defect information is possible.

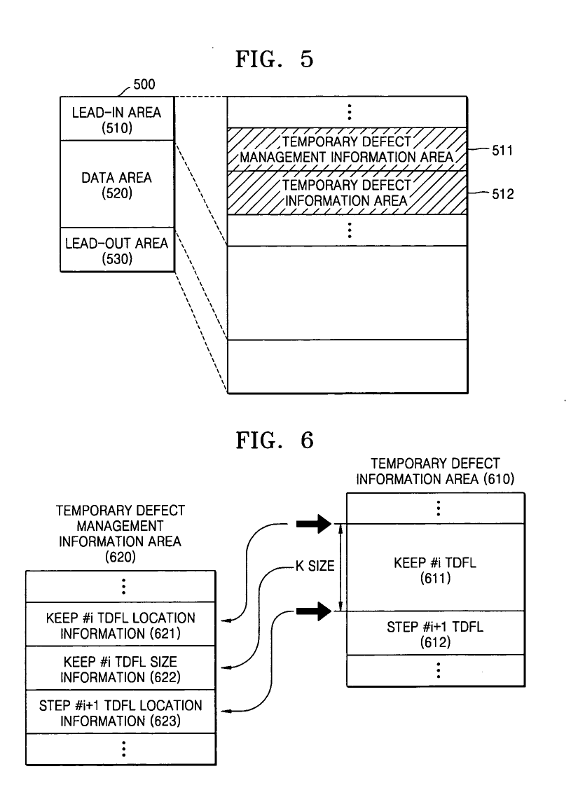

FIG. 5 illustrates the structure of a temporary defect information area 512 in which the temporary defect information is stored and a temporary defect management information area 511 in which the temporary defect management information is stored, according to an exemplary embodiment of the present invention. Referring to FIG. 5, an optical recording medium 500 includes a lead-in area 510, a data area 520, and a lead-out area 530.

The lead-in area 510 is located at an inner radius of the disk 500 and the lead-out area 530 is located at an outer radius of the disk 500. The data area is located between the lead-in area and the lead-out area. The data area is divided into a spare area and a user data area. The user data area is an area to which user data is recorded, and the spare area is an area that is provided to compensate for area loss due to defects in the user data area, that is, an area provided for defect management. If a defect is generated in data recorded to the user data area, the spare area is used as a replacement area for re-recording the defective data.

A temporary defect management area is an area in which information regarding defects is stored before finalizing and includes a temporary defect management information area 511 and a temporary defect information area 512.

Generally, if a disk is loaded in a disk loading apparatus, a recording/reproducing apparatus reads information stored in the lead-in area and the lead-out area of the disk and determines how the disk should be managed, how data should be recorded to the disk, and how data should be reproduced from the disk. The more information there is recorded in the lead-in area and/or the lead-out area, the longer the time required to begin recording or reproducing data after loading the disk. To solve such a problem and/or other problems, temporary defect management information and temporary defect information are recorded on a temporary defect management area separate from the defect management area of the lead-in area and/or the lead-out area.

If there is no data to be recorded on the disk (i.e., when data is finalized), only significant information among the temporary defect management information and temporary defect information that is updated many times and recorded is moved to the defect management area. Therefore, when the recording/reproducing apparatus reads defect management information from the disk, the recording/reproducing apparatus reads only the significant information stored in the defect management area, thereby rapidly performing initialization. Also, because the defect management information is recorded to a plurality of areas, reliability of the information is enhanced.

Because defect management is performed according to linear replacement, the temporary defect information includes information indicating where a defect is generated and information indicating where a new replacement area is located. The temporary defect management information is information used to manage the temporary defect information and includes information indicating where the temporary defect information is recorded. The temporary defect management information further includes information indicating a location in the user data area at which user data is finally recorded and information indicating a location in the spare area at which a final replacement area is located. Detailed data structures of the temporary defect information and the temporary defect management information will be described later.

The temporary defect information and the temporary defect management information are recorded whenever a recording operation is terminated. Information regarding a replacement area and information regarding defects generated in data recorded while a recording operation #0 is performed are recorded as temporary defect information #0 in the temporary defect management area. Information regarding a replacement area and information regarding defects generated in data recorded while a recording operation #1 is performed are recorded as temporary defect information #1 in the temporary defect management area. Further, management information for managing the temporary defect information #0, #1, . . . is recorded as temporary defect management information #0, #1, . . . in the temporary defect management area. If there is no data to be recorded to the data area or if a user does not want to record data to the data area, that is, when the data is finalized, the defect information recorded to the temporary defect information area and the defect management information recorded on the temporary defect management information area are recorded to the defect management area.

Arbitrary temporary defect information #i includes an accumulation of previous temporary defect information #0, #1, #2, . . . , #i−1. Accordingly, when the data is finalized, only defect information included in the final temporary defect information #i is read and the read defect information is recorded to the defect management area.

An area to which the temporary defect management information #i is recorded is about 1 cluster for a disk allowing high-density recording of data with several dozens of Giga bytes and an area to which the temporary defect information #i is recorded is 4-8 clusters. An amount of information recorded as the temporary defect information #i is approximately several Kbytes, however, when a minimal physical recording unit of a disk is a cluster, recording information for each cluster when updating newly recorded information is more manageable. A total amount of space required for defects for one disk is less than 5% of a recordable capacity of the disk. Considering that about 8 bytes of information is required for a defect and a cluster has a size of 64 Kbytes, the temporary defect information #i requires approximately 4-8 clusters.

The temporary defect management information area 511 and the temporary defect information area 512 is included in at least one of the lead-in area 510, the data area 520, and the lead-out area 530.

That is, the temporary defect management information and the temporary defect information can be updated during each operation and recorded to a temporary defect management information area and a temporary defect information area, respectively, which are included in at least one of the lead-in area, the data area, and the lead-out area; both the temporary defect management information and temporary defect information can be updated during each operation and recorded in a temporary defect area included in at least one of the lead-in area, the data area, and the lead-out area; or the temporary defect management information and the temporary defect information can be updated during each operation and recorded to a temporary defect management information area included in at least one or the lead-in area, the data area and the lead-out area, and to a temporary defect information area included in another area, respectively.

For example, as shown in FIG. 5, the temporary defect management information and the temporary defect information can be updated during each operation and recorded to the temporary defect management information area 511 and the temporary defect information area 512, respectively, which are separately included in the lead-in area 510; both the temporary defect management information and the temporary defect information can be updated during each operation and recorded to a temporary defect area included in the lead-in area 510; or the temporary defect management information and the temporary defect information can be updated during each operation and recorded to a temporary defect management area included in the lead-in area 510 and to a temporary defect information area included in the data area 520.

Recording the temporary defect management information and the temporary defect information to the same area twice, or to twice record the temporary defect management information and the temporary defect information to two different areas improves stability.

FIG. 6 illustrates a structure of information to be recorded to the temporary defect information area and the temporary defect management area according to an embodiment of the present invention.

Referring to FIG. 6, a temporary defect information area 610 stores keep #i temporary defect list (TDFL) 611 and step #i+1 TDFL 612.

The keep #i TDFL 611 is temporary defect information with a size equal to a multiple of a predetermined size, that is, temporary defect information which is continuously recorded. If the entire amount of temporary defect information is smaller than the predetermined size, the keep #i TDFL 611 is not recorded.

The step #i+1 TDFL 612 is accumulated temporary defect information of the entire temporary defect information excluding the temporary defect information with the size equal to the multiple of the predetermined size.

The temporary defect management area 620 also stores location information 621 for the keep #i TDFL, size information 622 for the keep #i TDFL, and location information 623 for the step #i+1 TDFL.

The location information 621 for the keep #i TDFL represents a location on a disk, the size information 622 for the keep #i TDFL represents a size of the keep #i TDFL, and the location information 623 for the step #i+1 TDFL represents a location on the disk.

Because the temporary defect information recorded on the temporary defect information area is located using only the location information 621 for keep #i TDFL, the size information 622 for keep #i TDFL, and the location information 623 for step #i+1 TDFL, which are recorded in the temporary defect management information area, it is possible to rapidly detect the temporary defect information and reducing the space required to store the temporary defect information is possible.

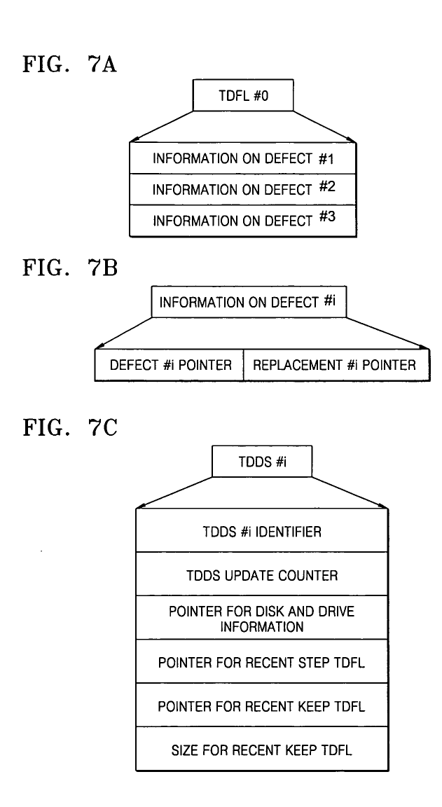

FIG. 7A illustrates a structure of TDFL #i.

Arbitrary temporary defect information of TDFL #i includes an identifier of TDFL #i and information regarding defects #1, #2, . . . , #k. The information regarding the defects #1, #2, . . . , #k is status information indicating where a defect is generated and where a new replacement area is located.

Referring to FIG. 7A, TDFL #0 stores information regarding a defect #1, information regarding a defect #2, and information regarding a defect #3. The information regarding the defect #1 includes information indicating where the defect #1 is generated and information indicating where a replacement area #1 is located. Likewise, the information regarding the defect #2 includes information indicating where the defect #2 is generated and information indicating where a replacement area #2 is located. Also, the information regarding the defect #3 includes information indicating where the defect #3 is generated and information indicating where a replacement area #3 is located.

For example, the temporary defect information TDFL #1 includes information regarding a defect #4 and information regarding a defect #5 in addition to the information of TDFL #0. That is, the TDFL #1 includes all generated defect information, that is, information regarding the defect #1, information regarding the defect #2, information regarding the defect #3, information regarding the defect #4, and information regarding the defect #5.

FIG. 7B illustrates a data structure of information regarding a defect #i. Referring to FIG. 7B, the information regarding the defect #i includes a pointer that indicates the defect #i and a pointer that indicates a replacement area #i. For example, the defect #i pointer can include a number indicating a physical sector where the defect #i starts. The replacement area #i pointer includes a location where the replacement area #i starts and/or where the replacement area #i terminates. For example, the pointer indicating the replacement area #i can include a number indicating a physical sector where the replacement area #i starts. The physical sector represents an area in which data corresponding to one sector on a disk is stored. An address that indicates a physical sector is called a “Physical Sector Number (PSN)”.

FIG. 7C illustrates a data structure of temporary defect management information TDDS #i recorded in a temporary defect management area according to the present invention.

Referring to FIG. 7C, the temporary defect management information TDDS #i includes an identifier of the TDDS #i, a TDDS update counter, a disk and drive information pointer, a recent step TDFL pointer, a recent keep TDFL pointer, and a size of recent keep TDFL.

The identifier of the TDDS #i is an identifier indicating the temporary defect management information TDDS #i, the TDDS update counter is a count value indicating a updated count of the temporary defect management information, and the disk and drive information pointer is information regarding a drive used for recording and/or reproducing.

The recent step TDFL pointer indicates the location of recent step TDFL, the recent keep TDFL pointer indicates a location on the disk at which recent keep TDFL is recorded, and the size of recent keep TDFL indicates a size of recent keep TDFL.

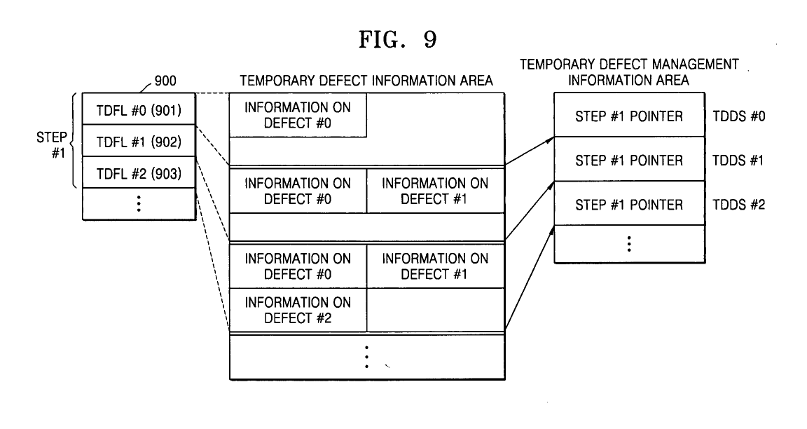

FIG. 8 is a flowchart illustrating a recording method according to an exemplary embodiment of the present invention. Hereinafter, the recording method will be described in detail with reference to FIGS. 9 through 11.

Referring to FIG. 8, if a size of temporary defect information to be updated is smaller than a predetermined size, K, the temporary defect information is accumulated and recorded as final temporary defect information in operation 810. Then, a location of the final temporary defect information is recorded on the temporary defect management area in operation 820. For the sake of discussion, K will be assumed to be equal to 4.

Referring to FIG. 9, in a first operation, TDFL #0 901 including information regarding a defect #0 is recorded in the temporary defect information area. Until the size of TDFL #i reaches a predetermined size of “4”, the TDFL #i is referred to as step #1 TDFL. Then, a pointer for the step #1 TDFL, that is, information indicating a location of the TDFL #0 is recorded in the TDDS #0 corresponding to the TDFL #0.

Next, in a second operation, TDFL #1 902 including information regarding a defect #1 in addition to the information regarding the defect #0 is recorded in the temporary defect information area. Also, a step #1 TDFL pointer, that is, information indicating a location of the TDFL #1 is recorded in the TDDS #1 corresponding to the TDFL #1.

Then, in a third operation, TDFL #2 903 including information regarding a defect #2 in addition to the information regarding the defect #0 and the information regarding the defect #1 is recorded in the temporary defect information area. Then, a step #1 TDFL pointer, that is, information indicating a location of the TDFL #2 is recorded in the TDDS #2 corresponding to the TDFL #2.

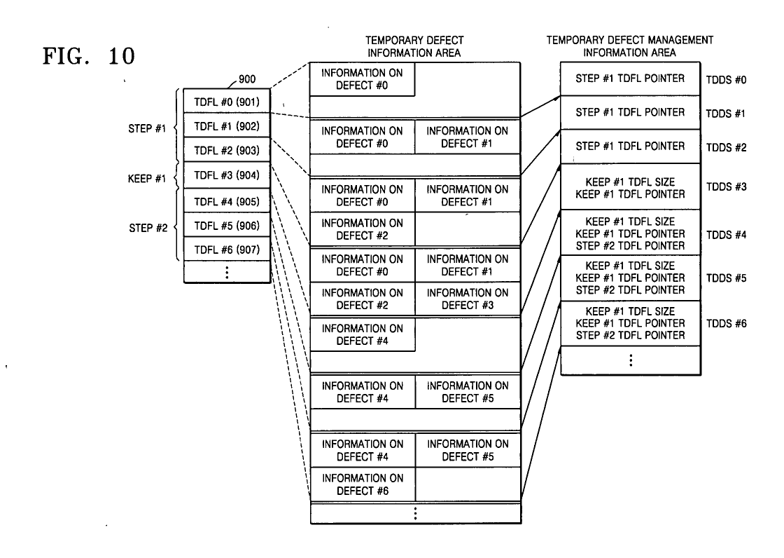

Referring to FIG. 10, in a fourth operation, TDFL #3 904 including information regarding a defect #3 in addition to the information regarding the defect #0, the information regarding the defect #1, and the information regarding the defect #2 is recorded in the temporary defect information area. Here, the TDFL #3 904 reaches the predetermined size. Thus, TDFL #3 904 is referred to as keep #1 TDFL. Then, a keep #1 TDFL pointer, that is, information indicating a location of the TDFL #3, and size information of the keep #1 TDFL are recorded to the TDDS #3 corresponding to the TDFL #3. In this case, because the final temporary defect information is the keep #1 TDFL, only the keep #1 TDFL pointer is recorded in the fourth operation.

If a size of temporary defect information to be updated exceeds the predetermined size, temporary defect information (keep #1 TDFL) with a predetermined size is recorded to the temporary defect information area and the accumulated temporary defect information (step #2 TDFL) excluding the keep #1 TDFL is recorded to a following temporary defect information area in operation 830. Next, the size and location of the keep #1 TDFL and the location of the step #2 TDFL pointer are recorded in the temporary defect management information area in operation 840.

Referring to FIG. 10, in a fifth operation, TDFL #4 905 including information regarding a defect #4 of the accumulated temporary defect information excluding the keep #1 TDFL 904 is recorded to the temporary defect information area. Here, the TDFL #4 is a step #2 TDFL. Then, a keep #1 TDFL pointer indicating a location of the TDFL #3, size information of the keep #1 TDFL, and a step #2 TDFL pointer are recorded in the TDDS #4 corresponding to the TDFL #4.

In a sixth operation, as in the fifth operation, TDFL #5 906 including information regarding a defect #5 in addition to the information regarding the defect #4 excluding the keep #1 TDFL 904 is recorded in the temporary defect information area. Also, the keep #1 TDFL pointer, the size information of the keep #1 TDFL, and the step #2 TDFL pointer are recorded in a TDDS #5 corresponding to the TDFL #5. Here, the step #2 TDFL pointer indicates a location of the TDFL #5.

Likewise, in a seventh operation, TDFL #6 907 including information regarding a defect #6 in addition to the information regarding the defect #4 and the information regarding the defect #5, which are the accumulated temporary defect information excluding the keep #1 TDFL 904, is recorded in the temporary defect information area. Then, the keep #1 TDFL pointer and a step #2 TDFL pointer are recorded in a TDDS #6 corresponding to the TDFL #6. Here, the step #2 TDFL pointer indicates a location of the TDFL #6.

As such, the accumulated temporary defect information (step #2 TDFL) excluding the keep #1 TDFL is accumulated and recorded until the size of the accumulated temporary defect information reaches the predetermined size, and the size and location of the keep #1 TDFL and the location of the step #2 TDFL are recorded in the temporary defect management information area in operation 850.

Next, if the size of the step #2 TDFL exceeds the predetermined size (K), the keep #1 TDFL and the step #2 TDFL with the size of K are arranged and recorded to the temporary defect information area as a keep #2 TDFL with a size of 2 K, and the accumulated temporary defect information (step #3 TDFL) excluding the keep #2 TDFL with the size of 2 K among the entire temporary defect information is recorded in the following temporary defect information area in operation 860. Also, a location and size of the keep #2 TDFL and a location of the step #3 TDFL are recorded to the temporary defect management information area in operation 870.

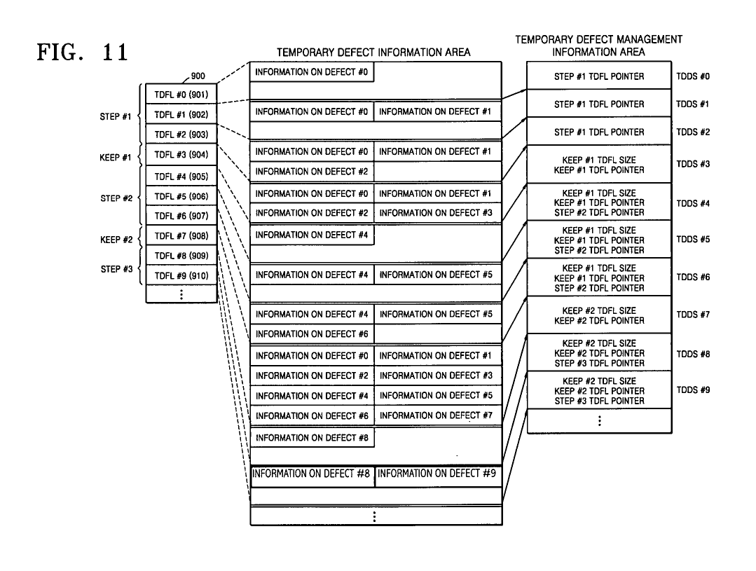

Referring to FIG. 11, TDFL including information regarding a defect #7 should be recorded in the temporary defect information area in an eighth operation, however, the size of the step #2 TDFL reaches the predetermined size when the information regarding the defect #7 is added to the TDFL #6 907 recorded in the seventh operation. Thus, the step #2 TDFL of the predetermined size is arranged with the keep #1 TDFL so that both the step #2 TDFL and the keep #1 TDFL are recorded as a keep #2 TDFL at the same time. That is, in the eighth operation, TDFL #7 908 including the information regarding the defect #0 to the information regarding the defect #7 is continuously recorded in the temporary defect information area. Then, the keep #2 TDFL pointer indicating a location of the TDFL #7 and information indicating a size of the keep #2 TDFL are recorded in a TDDS #7 corresponding to the TDFL #7. As such, by continuously recording temporary defect information corresponding to a multiple of a predetermined size at a time, it is unnecessary to repeatedly search for the temporary defect information area in order to find final temporary defect information.

As with the case of the step #2 TDFL, the accumulated temporary defect information (step #3 TDFL) excluding the keep #2 TDFL is accumulated and recorded to the temporary defect information area until the accumulated temporary defect information being recorded reaches the predetermined size of K, and a location and size of the keep #2 TDFL and a location of the step #3 TDFL are recorded to the temporary defect management information area in operation 880.

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention may also be embodied as a computer readable program code unit stored on a computer readable medium, for causing a number of computer systems connected via a network to affect distributed processing.

As described above, according to the present invention, rapidly searching for temporary defect information while saving a capacity of a temporary defect information area included in an optical recording medium is possible.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A recording method, comprising:
separately recording to an optical recording medium:
temporary defect information with a size equal to a multiple (N=0,1,2, . . . ) of a predetermined size (K) among entire temporary defect information, and
remaining temporary defect information, excluding the temporary defect information with the size equal to K×N, among the entire temporary defect information.

2. The recording method of claim 1, further comprising:
recording size information of the temporary defect information with the size equal to K×N, information indicating a location of the temporary defect information with the size equal to K×N, and information indicating a location of the remaining temporary defect information, excluding the temporary defect information with the size equal to K×N, to the optical recording medium.

3. The recording method of claim 1, wherein the optical recording medium is a write once medium.

4. A recording method, comprising:
continuously recording temporary defect information with a size equal to a multiple (N=0, 1, 2, . . . ) of a predetermined size (K) among entire temporary defect information to at least one portion of an optical recording medium; and
accumulating and recording remaining temporary defect information, excluding the temporary defect information with the size equal to K×N, among the entire temporary defect information to the optical recording medium during each operation, until a size of the accumulated temporary defect information reaches K.

5. The recording method of claim 4, further comprising:
recording size information of the temporary defect information with the size (K×N) equal to the multiple (N=0, 1, 2, . . . ) of the predetermined size (K), information indicating a location of the temporary defect information with the size equal to the multiple of the predetermined size, and information indicating a location of the accumulated temporary defect information, to the optical recording medium.

6. The recording method of claim 4, further comprising:
if a size of the remaining temporary defect information reaches the predetermined size K during one of the operations, continuously recording the temporary defect information with the size equal to K×N and the remaining temporary defect information, excluding the temporary defect information with the size equal to K×N, to at least one portion of the optical recording medium.

7. The recording method of claim 6, further comprising:
recording size information (K×N+K) of the continuously recorded temporary defect information and information indicating a location of the continuously recorded temporary defect information to the optical recording medium.

8. A recording apparatus, comprising:
a controller controlling separately recording temporary defect information with a size equal to a multiple (N=0,1,2, . . . ) of a predetermined size (K) among entire temporary defect information and remaining temporary defect information, excluding the temporary defect information with the size equal to K×N, among the entire temporary defect information to an optical recording medium.

9. The recording apparatus of claim 8, wherein the controller further controls recording size information of the temporary defect information with the size equal to K×N, information indicating a location of the temporary defect information with the size equal to K×N and information indicating a location of the remaining temporary defect information, excluding the temporary defect information with the size equal to K×N, to the optical recording medium.

10. The recording apparatus of claim 8, wherein the optical recording medium is a write once medium.

11. A recording apparatus, comprising:
a first controller which controls continuously recording temporary defect information with a size equal to a multiple (N=0, 1, 2, . . . ) of a predetermined size (K) among entire temporary defect information to at least one portion of an optical recording medium; and
a second controller which controls accumulatively recording remaining temporary defect information, excluding the temporary defect information with the size equal to K×N, among the entire temporary information to the optical recording medium during each operation, until a size of the accumulated temporary defect information reaches K.

12. The recording apparatus of claim 11, further comprising:
a third controller which controls recording the temporary defect information with the size equal to K×N, information indicating a location of the temporary defect information with the size equal to K×N, and information indicating a location of the remaining temporary defect information to the optical recording medium.

13. The recording apparatus of claim 11, further comprising:
a fourth controller which controls continuously recording the temporary defect information with the size equal to K×N and the accumulated temporary defect information with the size equal to K to at least one portion of the optical recording medium if a size of the remaining temporary defect information reaches K during one of the operations.

14. The recording apparatus of claim 13, further comprising:
a fifth controller which controls recording information with a size (K×N+K) including the continuously recorded temporary defect information and information indicating a location of the continuously recorded temporary defect information to the optical recording medium.

15. An optical recording medium, comprising:
a first area, in which temporary defect information with a size equal to a multiple (N=0, 1, 2, . . . ) of a predetermined size K among entire temporary defect information is recorded; and
a second area, in which the temporary defect information with the size equal to K×N, and remaining temporary defect information, excluding the temporary defect information with the size equal to K×N, among the entire temporary defect information are separately recorded.

16. The optical recording medium of claim 15, further comprising:
a third area, in which size information of the temporary defect information with the size equal to K×N of the predetermined size, information indicating a location of the temporary defect information with the size equal to K×N, and information indicating a location of the accumulated temporary defect information is recorded.

17. The optical recording medium of claim 15, wherein the optical recording medium is a write once medium.

18. An optical recording medium, comprising:
a first area, in which temporary defect information with a size equal to a multiple (N=0, 1, 2, . . . ) of a predetermined size K among entire temporary defect information is continuously recorded; and
a second area, in which remaining temporary defect information, excluding the temporary defect information with the size equal to K×N, among the entire temporary defect information is accumulatively recorded during each operation until a size of the accumulated temporary defect information reaches the predetermined size K.

19. The optical recording medium of claim 18, further comprising:
a third area, in which size information of the temporary defect information with the size equal to K×N, information indicating a location of the temporary defect information with the size equal to K×N, and information indicating a location of the accumulated temporary defect information is recorded.

20. The optical recording medium of claim 18, further comprising:
a fourth area, in which if a size of the remaining temporary defect information reaches the predetermined size K in the operation, the temporary defect information with the size equal to K×N and the remaining temporary defect information are continuously recorded.

21. The optical recording medium of claim 20, further comprising:
a fifth area, in which size information of the continuously recorded temporary defect information and information indicating a location of the continuously recorded temporary defect information are recorded.

22. A computer-readable medium having embodied thereon a computer program executing a recording method, comprising:
separately storing temporary defect information with a size equal to a multiple (N=0, 1, 2, . . . ) of a predetermined size (K) among entire temporary defect information, and accumulated temporary defect information, excluding the temporary defect information with the size equal to K×N, among the entire temporary defect information; and
storing size information of the temporary defect information with the size equal to K×N, information indicating a location of the temporary defect information with the size equal to K×N, and information indicating a location of the remaining temporary defect information.

23. A recording medium defect management method, comprising: accumulating temporary defect information during a verify after write operation;
recording the temporary defect information in a first area on the recording medium when the accumulated temporary defect information reaches a predetermined size; and
recording management information in a second area on the recording medium corresponding to the predetermined size and a location of the accumulated temporary defect information.

24. The method of claim 23, further comprising:
accumulating excess temporary defect information when the accumulated temporary defect information exceeds the predetermined size;
updating the recorded temporary defect information in the first area by recording the accumulated excess temporary defect information adjacent to the accumulated temporary defect information; and
updating the management information in the second area on the recording medium to include management information corresponding to a location of the accumulated excess temporary defect information.

25. The method of claim 24, wherein the updating the management information comprises storing a step #i pointer corresponding to the location of the accumulated excess temporary defect information.

26. The method of claim 24, further comprising:
recording a total temporary defect information when the accumulated excess temporary defect information reaches the predetermined size corresponding to the accumulated temporary defect information and the accumulated excess temporary defect information; and
updating the management information in the second area on the recording medium corresponding to a location and size of the total temporary defect information.

27. The method of claim 26, wherein the size of the recorded total temporary defect information is equal to a multiple of the predetermined size.

28. The method of claim 26, further comprising:
finalizing the temporary defect information, wherein only a significant temporary defect information is read; and
recording the read significant temporary defect information in a predetermined defect management area of the recording medium.

29. The method of claim 26, wherein the updating the management information comprises storing a keep #i size and a keep #i pointer corresponding to the location and the size of the total temporary defect information.

30. A computer-readable medium having embodied thereon a computer program executing a recording method, comprising:
accumulating temporary defect information during a verify after write operation;
recording the temporary defect information in a first area on the recording medium when the accumulated temporary defect information reaches a predetermined size; and
recording management information in a second area on the recording medium corresponding to the predetermined size and a location of the accumulated temporary defect information.
